(19) United States
(12) Patent Application Publication
(10) Pub. No.: US 2026/0051600 A1
(43) Pub. Date: Feb. 19, 2026

(54) BATTERY TOWER DESIGN FOR HEAVY-DUTY ELECTRIC POWERTRAINS

(71) Applicant: Caterpillar Inc., Peoria, IL (US)

(72) Inventors: Wellington Y. Kwok, Dunlap, IL (US); Strauss Carl Langrud, Peoria, IL (US); Peitong Jin, Dunlap, IL (US); Ohm Sachin Vyas, Geneva, IL (US); Caleb Nathan Alt, East Peoria, IL (US); Madisyn Cae Lee, Alexis, IL (US); Jacob Andrew Polowy, Madison, WI (US)

(73) Assignee: Caterpillar Inc., Peoria, IL (US)

(21) Appl. No.: 18/807,082

(22) Filed: Aug. 16, 2024

(51) Int. Cl. H01M 50/258; H01M 10/04; H01M 10/6551; H01M 10/6556; H01M 50/249; H01M 50/293; H01M 50/507

(52) U.S. Cl. CPC H01M 50/258; H01M 10/0481; H01M 10/6551; H01M 10/6556; H01M 50/249; H01M 50/293; H01M 50/507; H01M 2220/20

(57) ABSTRACT

This disclosure describes a battery tower design using pouch cell or blade cell batteries to build modular towers and assemble battery units to fit within electrified heavy-duty equipment. The battery units are modular to enable expansion of the battery units horizontally and/or vertically to fit within irregular-shaped compartments originally intended for non-electric powertrain components. The battery towers are modular units with frames for holding battery cells with their width in a vertical direction and stacking the cells vertically along a length of a frame that includes passive and active cooling components.

### TECHNICAL FIELD

The present application relates to battery pack systems for heavy duty powertrain applications. More particularly, the present application relates to a design and system for a cell-to-pack (CTP) assembly to fill a non-traditional installation space (e.g., filling an existing fuel-engine compartment) that incorporates an integrated structural and thermal design that exposes large surfaces of battery cells to a thermal interface for thermal management.

### BACKGROUND

Electrification of heavy-duty and/or offroad systems in large-scale construction equipment and hauling vehicles has grown rapidly in the recent years. In some applications, a traditional diesel engine powertrain is directly replaced by installing a full-electric powertrain integrated with a battery system. Without a complete redesign of the machine or vehicle chassis, the battery system needs to fit within existing spaces on the machine or vehicle chassis.

Typical automotive design configurations for battery systems are in a flat arrangement that is designed specifically to fit in the underbody of a passenger vehicle or floor of an electric bus. Electrification of large machines, equipment, mining trucks, etc., replaces the large diesel engine with electric powertrain and leaves behind a large irregular, often narrow and tall “empty” engine compartment that does not fit well with common battery module or pack designs that are designed for flat arrangements.

Further, cell-to-pack (CTP) battery configurations simplify the manufacturing process and removes intermediate states of manufacturing. Additionally, cell-to-pack arrangements can reduce the weight of the battery pack, thereby improving the energy density. An example CTP battery pack is described in Chinese Patent Publication CN216850179, titled “CTP Battery Pack and Automobile” (hereinafter referred to as the '179 document). In particular, the '179 document describes a CTP battery pack with a box body structure and square-shell battery cells stacked in the box body, with heat-conducting glue coated between the bottom surface of the box body and the bottom surface of each battery cell. The CTP battery back includes two cell groups arranged side by side within the box body and limit strips below the cell groups and therefore provides for a uniform height or thickness of the CTP battery pack.

Although the system described in the '179 document is configured to provide a CTP battery pack, it does not provide for configurable and/or expandable arrangements to enable filling of irregular spaces left behind in heavy-duty machinery by removing previous drivetrain equipment.

An example of a vertically stacked battery structure is described in Japanese Patent Publication JP7120482B1, titled “Storage Battery System” (hereinafter referred to as the '482 document). In particular, the '482 document describes a storage battery system with improved load resistance. The storage battery system include a plurality of battery modules with a pillar portion extending in a stacking direction. The pillar portion includes a pair of pillars arranged apart from each other with a plurality of battery modules between the pair of pillars. The battery modules within the stack are arranged horizontally on top of each other. The battery modules have a rectangular box-shape with the thickness shorter than the length or width. The battery modules are stacked by thickness (e.g., stacked on top of each other such that the stack has a height of n thicknesses).

Although the '482 document describes a stacked battery tower, it provides for the battery cells to be stacked in a horizontal orientation (e.g., stacked along the thickness of the cells) which may create non-uniform compression along the stack of the battery modules.

Examples of the present disclosure are directed toward overcoming the deficiencies described above.

### SUMMARY OF THE INVENTION

In examples, the systems and techniques described herein may provide a battery tower for electrifying a vehicle, the battery tower configured to fit within an existing compartment of a vehicle vacated by a previous motive system of the vehicle. The battery tower includes a plurality of modular structures shaped to fit within an existing compartment of a heavy-duty vehicle, where a modular structure of the plurality of modular structures include a first frame having an elongated rectangular shape and defining a first opening having a first length and a first width, a second frame having the elongated rectangular shape and defining a second opening having the first length and the first width, a plurality of battery cells arranged in a stack configuration, where the stack configuration may include a thickness of two battery cells and a height of at least two battery cells, and a compressible material positioned between adjacent battery cells of the plurality of battery cells in the stack configuration, where: the stack configuration is situated within the first opening of the first frame and the second opening of the second frame; and the first frame and the second frame compress the compressible material.

The battery tower may include a first end plate positioned at a first side of the plurality of modular structures and a second end plate positioned at a second side of the plurality of modular structures opposite the first side, where the first end plate and second end plate are connected together to secure and compress the plurality of modular structures. The first bus bars may include a conductive material held in place by a third frame and configured to electrically connect adjacent battery cells and the second bus bars may include the conductive material held in place by a fourth frame and configured to electrically connect adjacent battery cells. The battery tower may include a cold plate extending across at least a portion of a top of the plurality of modular structures. The cold plate may define a passageway through the cold plate and a plurality of fins extending from a wall of the passageway and configured to transfer heat to a working fluid of the cold plate. The battery tower may include heat pipes positioned between adjacent modular structures of the plurality of modular structures. The battery tower may include a heat management device positioned between adjacent battery cells, the heat management device configured to selectively heat the plurality of battery cells.

In an illustrative example, one general aspect includes a battery assembly for a heavy-duty vehicle formed of battery tower modules. The battery tower module includes a first frame having an elongated rectangular shape and defining a first opening having a first length and a first width. The module also includes a second frame having the elongated rectangular shape and defining a second opening having the first length and the first width. The module may also include a plurality of battery cells having an elongated rectangular shape arranged in a stack configuration with the first frame surrounding a first end of the stack configuration and the second frame surrounding a second end of the stack configuration to secure the plurality of battery cells, where a battery cell of the plurality of battery cells has first side, a second side, a top edge, and a bottom edge, and the stack configuration may include the plurality of battery cells stacked with the top edge of a first battery cell adjacent a bottom edge of a second battery cell and a first side of the first battery cell adjacent a second side of a third battery. The module may also include a compressible material positioned between adjacent battery cells of the plurality of battery cells in the stack configuration.

In an illustrative example, one general aspect includes a battery assembly for a heavy-duty vehicle formed of battery tower modules. In an illustrative example, one general aspect includes. The battery assembly includes a first end plate positioned at a first end. The assembly may also include a second end plate positioned at a second end of the battery module. The assembly may also include a plurality of modular battery towers positioned between the first end plate and the second end plate, a modular battery tower of the plurality of modular battery towers may include a first frame having an elongated rectangular shape and defining a first opening having a first length and a first width, a second frame having the elongated rectangular shape and defining a second opening having the first length and the first width, a plurality of battery cells arranged in a stack configuration with the first frame surrounding a first end of the stack configuration and the second frame surrounding a second end of the stack configuration to secure the plurality of battery cells, and a compressible material positioned between adjacent battery cells of the plurality of battery cells in the stack configuration.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates a chassis of a heavy-duty machine with battery towers in spaces left by removing a previous powertrain, according to at least one example.

FIG. 2 illustrates an exploded view of a battery assembly with bus bars and covers, according to at least one example.

FIG. 3 illustrates an exploded view of a battery assembly showing battery towers, support base, and end plates, according to at least one example.

FIG. 4 illustrates a battery assembly including a cold plate positioned at a top end of the battery towers, according to at least one example.

FIG. 5 illustrates a battery assembly and compression rods for compressing the battery towers together between end plates, according to at least one example.

FIG. 6 illustrates a portion of a battery tower during an assembly process, according to at least one example.

FIG. 7 illustrates the portion of the battery tower of FIG. 6, after assembly, according to at least one example.

FIG. 8 illustrates an assembled battery tower, for use in building a battery assembly, according to at least one example.

FIGS. 9A-9B illustrate a battery tower with compressive material and heat pipes, according to at least one example.

FIGS. 10A-10B illustrate example sections of battery towers in a battery assembly before and after compression during assembly, according to at least one example.

FIGS. 11A-11C illustrate a battery tower having a central support frame during assembly, according to at least one example.

FIGS. 12A-12B illustrate a battery tower with heat pipes on an outer surface, according to at least one example.

FIG. 13 illustrates a section view of a battery assembly showing a flow path for coolant through an active cooling system, according to at least one example.

FIG. 14 illustrates a section view of a battery assembly showing a flow path for coolant through an active cooling system, according to at least one example.

FIG. 15 illustrates a section view of a battery assembly showing a flow path for coolant through an active cooling system, according to at least one example.

FIGS. 16A-16B illustrate a first end and a second end of a battery tower showing bus bars for electrical connections, according to at least one example.

FIG. 17 illustrates a bus bar for connecting terminals of adjacent battery cells, according to at least one example.

FIG. 18 illustrates bus bars and bus bar covers for aligning, covering, and protecting bus bars after installation, according to at least one example.

FIG. 19 illustrates several battery towers illustrating bus bar connections between battery cells and between towers, according to at least one example.

FIGS. 20A-20D illustrate a cold plate for thermal management of a battery assembly, according to at least one example.

### DETAILED DESCRIPTION

Wherever possible, the same reference numbers will be used throughout the drawings to refer to the same or like parts. In the figures, the left-most digit(s) of a reference number identifies the figure in which the reference number first appears.

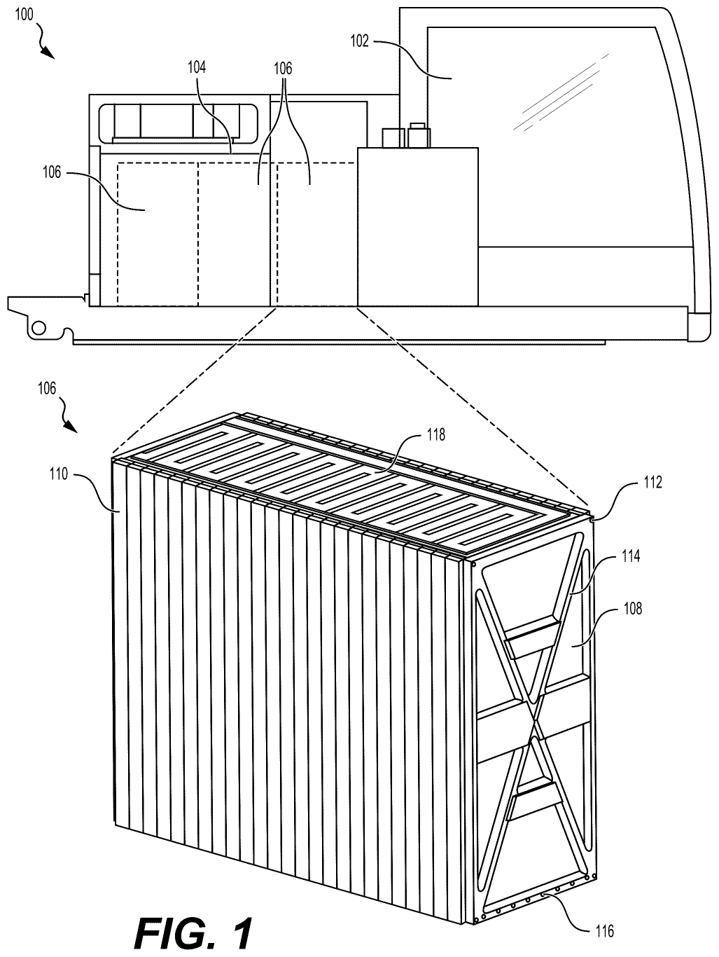

FIG. 1 illustrates a chassis 100 of a heavy-duty machine with battery assemblies 106 in spaces 104 left by removing a previous powertrain, according to at least one example. The chassis 100 may include a cabin 102 for an operator of the heavy-duty machine as well as other control and working components. In such a chassis 100, such as was designed for a diesel fuel powertrain, or other such fuels source, the spaces remaining in the chassis may not be suitable for efficient packing of battery assemblies 106 based on existing battery structures. The systems and structures described herein provide for a battery system that applies a cell-to-pack concept to fill such non-traditional spaces within the chassis 100.

The battery assemblies 106 provide for an integrated structural and thermal design through the use of battery towers 110 positioned and held together between end plates 108 that position and support the battery towers 110 of battery cells into the battery assemblies 106 that fit into a non-traditional battery compartment, such as a compartment left behind by a previous propulsion system of an electrified vehicle. The battery towers 110 are sandwiched between end plates 108 and held together, and compressed, using compression rods 112. The end plates 108 are depicted with particular geometry 114 to aid in the strength and rigidity of the end plates 108 while also reducing the overall weight of the battery assemblies 106. The end plates 108 further connect to a support (not shown in FIG. 1) through connections 116 and to a cold plate 118 that provides thermal management for the battery assembly 106. The battery assemblies 106 use a cell-to-pack configuration to enable efficient packing as well as simplified maintenance and assembly of the battery assemblies 106.

Electrification of heavy-duty equipment, large machines, mining trucks, etc., may involve replacement of a large diesel engine with an electric powertrain that occupies less space and leaves behind large irregular cavities for spaces 104. In some examples, the space no longer occupied by the powertrain may be narrow and tall, such as an engine compartment that does not fit well with common battery module or pack designs. The use of a cell-to-pack (CTP) configuration and assembly concept enables use and efficient packing within the spaces of the chassis 100 previously occupied by the powertrain components while also improving energy density, cooling, and integral structural components.

While traditional battery packs comprise cells, assembled into modules, and then integrated into a pack structure, the CTP design eliminates the need for modules by directly integrating cells into the pack structure. In doing so, the CTP design simplifies the overall architecture, reduces weight and volume, and improves energy density and thermal management. The CTP integrates battery cells directly into a pack without the intermediate step of modules, thereby further enhancing the volumetric energy density of battery mold and system compared to the conventional pack.

The CTP design of the battery assembly 106 enables improved energy density over typical battery arrangements due to the reduced structure by avoiding implementation into a module level. Accordingly, the energy density of the battery assembly 106 is improved over conventional battery pack designs. The battery assembly 106 provides for reduced weight and volume as a result of the higher energy density than a conventional battery system, in particular at least because the battery assembly 106 does not use additional casings, connectors, and other components that may be implemented in a battery module. Additionally, the battery assembly 106 may be produced with fewer steps, complexity, and cost than typical battery packs that are arranged from cells into modules and then into packs.

As depicted in FIG. 1, the battery assemblies 106 fit within spaces 104 left behind by a powertrain assembly. The battery assemblies 106 are designed into a battery tower constructed from a number of structural battery columns with integrated cooling and/or temperature regulating devices. The battery assembly 106 is shown with battery towers 110 arranged into the battery columns.

The battery assembly 106 uses a blade cell design battery cell, with the battery towers 110 formed of repeating units of positive and negative electrodes with separators interleafed in-between stacked and inserted into a long “blade” prismatic cell enclosure with cell terminals on opposite ends. Individual blade cells are stacked vertically within the battery towers 110 to form a thin tall cell array held together by a pair of structural ring frames with shelves. In examples, heat pipes are then pressed against one side (e.g., an outer surface) of the battery cell's largest surface to effect heat removal from the battery cells during operation. The battery tower 110 with integrated thermal management is arranged horizontally with other battery towers 110 to form the battery assembly 106, in which two end plates 108 are used to compress the battery towers 110 using compression rods 112 and mounted onto a bottom plate and a cold plate 118.

The battery towers 110 arrange and maintain the battery cells within an exoskeleton structure made of one or more frames defining a ring-shape as wells a multiple shelves, with the battery cells held therein. The battery assembly 106 achieves a high volumetric cell-to-pack ratio (VCTP), which is defined as the ratio of the final exterior volume of the battery pack to the sum of volume of all individual blade cells, of about 60% wherein typical VCTP based on common approach of cell-to-module and then module-to-pack with top-terminal prismatic cells be in the range of 40-50%. The battery assembly 106 uses, in examples, a combination of active and passive cooling mechanisms. In examples, a heat pipe design may be used to transport heat vertically along the battery towers 110 and a cold plate 118 may be used as a cold condensing source at a top end of the battery towers 110. In examples, the shelves or separations between blade cells may include thermal management components such as heating tape to enable heating of battery cells when the battery temperature is below a target range.

In an example, the battery assembly 106 may use standard VDA format pouch cells for the battery cells, which describe a pouch cell with terminal lags on opposite ends and of standard dimensions designed module assembly. In the battery assembly 106, individual battery cells are secured within a ring-shaped frame to form a column structure. The battery cells may then be electrically coupled in series via electrical connections such as busbars. The battery cells may be oriented such that along the length (e.g., height) of the column, adjacent battery cells have positive and negative terminals alternating. For example, along a first side of the battery assembly 106, the battery cells may be arranged with a positive terminal and the next battery cell vertically in the column may have a negative terminal, such that the battery cells may be electrically coupled with minimal additional structure and components.

The battery cells are stacked in a vertical arrangement such that a largest planar surface of the exterior of the battery cells is exposed to and/or contacts a thermal management component such as heat pipes that run the length of the battery towers 110. The thermal management component provides for heat transfer to and/or from each of the battery cells. The frames may arrange battery cells in a configuration that is two cell thicknesses (e.g., two cells thick) such that each cell has one largest surface adjacent an exterior surface of the battery tower 110. The frame provides for a cell pair (e.g., a pair of battery cells) to be positioned next to each other within the ring-shaped frame (with cell pairs stacked vertically) and thereby reduce the number of thermal regulation devices needed for the battery assembly 106.

In some examples, the battery cells may be electrically connected in series starting from one end of the column (e.g., at a top or bottom of the battery assembly 106) and continuously connect in series with the battery cells along the length of the frame and then along the length in an opposite direction on the opposite end of the battery cells. In this manner, the positive and negative terminals of the battery cells are adjacent along a column in the battery assembly.

A thin heat-transfer medium is positioned between the vertical columns of the battery towers 110, for example along the flat surfaces of the battery cells (particularly the surfaces having the largest surface area of all the surfaces of the battery cells). A single heat-transfer medium may be provided between two columns of battery towers 110, such that each battery tower 110 is in physical contact on at least one surface with the heat-transfer medium. In some examples, a heat transfer medium or system may be positioned between each column of battery cells within the frame as well such that each battery cell contacts the heat-transfer medium on at least two surfaces.

The cold plate 118 may include an active cooling system such as liquid cold plate or passive cooling device such as heat pipes, vapor chambers, and other such components, so that heat generated from the battery cells is transported along the length of the battery towers 110 (e.g., along a vertical plane) to a first end of the frame where a second heat-transfer medium, such as a cold plate, is positioned and thermally coupled with the vertical heat-transfer medium to provide consistent and continual heat removal. In some examples, the heat transfer systems may use passive cooling, evaporative cooling, active cooling, conduction, convection, a combination thereof, or any other mechanism to transfer heat along the heat-transfer medium of the frame to a second heat transfer system to transport heat away from the battery assembly 106.

The cold plate 118, in examples, includes heat fins within a traditional cooling channel in the cold plate 118, where the heat fins are attached directly to the heat removal (bottom) plate of the cold plate 118 that interfaces with the battery towers 110 to provide additional heat-transfer surfaces for the circulating liquid and therefore increased heat transfer to the coolant.

As an example, for illustration, the heat fins may have a thickness that corresponds to a distance between adjacent heat fins. In an example the heat fins may have a thickness of at or around 2.0 mm with an equal spacing of 1.90 to 2.0 mm across the liquid channel. The 2.0 mm fin thickness may provide maximal heat-transfer efficiency in the vertical direction, wherein a thinner dimension of fins may promote less effective heat conduction. Thinner heat fins also result in flow restriction and lead to greater pressure drop. The combination of 2.0 mm heat fin and 2.0 mm spacing provides an optimal flow design as it promotes turbulent flow regime for greater heat-transfer coefficient and reasonable pressure drop.

In examples, the heat fins are 10 mm tall, or around a third of the total height of the liquid channel. The heat fin height may be optimized for heat conduction capability along the length of the heat fin. In an example, the range of the heat fin height may be 8 to 15 mm. Though geometry and particular dimensions may vary, and those with skill in the art will understand and adjust the height ranges accordingly as described herein. The cold plate 118 design improves the heat-transfer efficiency by as much as 300% and eliminates the needs for high liquid flow rate and/or chilled coolant to near-zero or sub-zero temperature in order to result in the same or similar heat transfer function.

Manufacturing of the finned cold plate may be accomplished by (1) direct machining of an aluminum plate to create the large and finned channels, (2) brazing of the stamped fin sheet onto the flow channel floor, or (3) other alternative advanced manufacturing techniques.

A compressible member is positioned on an outside surface of the battery towers 110. The battery towers 110 contact the compressible material on a lateral surface. The compressible member may include a foam, plastic, composite, or other material to provide cell compression to the battery towers 110 and associated battery cells as may be required for pouch cell batteries. In some examples, the compressible member may include a shielding component to shield, insulate, and/or otherwise prevent heat from traveling between adjacent battery towers.

The battery towers 110 and frames that support the battery cells provide for an expandable structure that may be used to build the battery assembly 106 into any desirable shape or configuration using the frames. In particular, odd shaped or oddly dimensioned compartments of the chassis 100 can be filled with battery assemblies 106 built using the systems described herein. A battery tower 110 of battery cells may be formed by a frame with battery cells contained within the ring-shaped frame in a vertical orientation. The vertical orientation may be defined such that the thickness of the battery cells is perpendicular to the length of the frame and the length of the battery cells is perpendicular to both the length of the frame and the thickness. The battery cells of the battery tower 110 are connected to one another in series, with adjacent battery towers connected one to another. The battery towers 110 and/or battery assembly 106 may be sized and/or designed to meet or reach a target voltage, for example including a target voltage that remains below a threshold for various operating, maintenance, and/or safety reasons.

The battery assembly 106, with the battery cells oriented vertically, as shown in FIG. 1, with the surface of the battery cell having the largest surface area of all the surfaces on the battery cell (e.g., the surface defined by the length and width of the battery cell) provides for increased surface area contact and thermal transfer to heat transfer components and systems of the battery assembly 106. The increased heat transfer through the large surface area of the face of the battery cell allows for improved battery performance, lifespan, and safety. Further, due to the increased thermal conductivity to the heat transfer components, the battery assembly 106 may be charged and/or discharged at a more rapid rate without overheating or damaging the battery assembly 106. The battery assembly 106 provides for improved thermal control and uniformity across the battery cells that provides the benefits above as well as ensuring optimal performance under various operating conditions.

In an example, the battery cells may include automotive blade cells, e.g., an L600 blade cell having dimensions of about 590 mm in length by about 120 mm in width by about 22 mm in thickness. The automotive blade cells include positive and negative terminals at opposite ends of the battery cell along the length. Unlike a pouch cell design, the automotive blade cells may be enclosed and/or encased in hard prismatic cases with certain pre-compression forces.

The automotive blade cells may be stacked vertically, as shown in FIG. 1, and secured within a frame and then electrically connected in series in the same manner as described above, e.g., with connections from positive to negative or negative to positive terminals along a first side of the battery tower 110 and along a second side of the battery cover to place the battery cells in electrical connection in series.

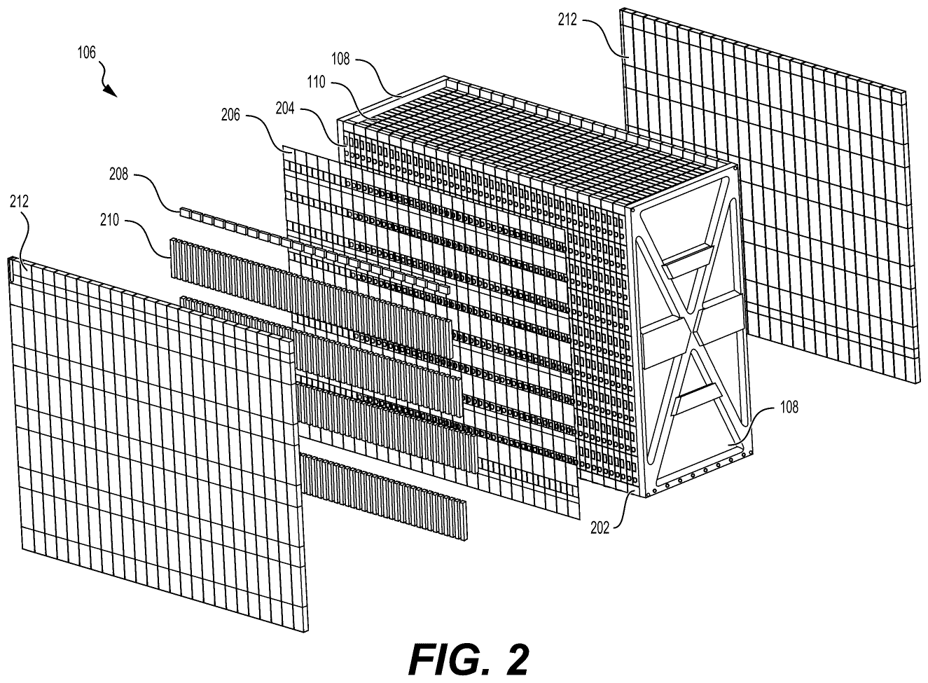

FIG. 2 illustrates an exploded view of a battery assembly 106 with bus bars and covers, according to at least one example. The battery assembly 106 includes end plates 108 with battery towers 110 positioned therebetween. The battery assembly 106 illustrates bus bars for electrically connecting battery cells within battery towers 110 as well as electrically connecting adjacent battery towers in series to produce the battery assembly having a target energy storage capacity (e.g., a target voltage etc.). The battery assembly 106 further includes a support base 202 that supports the battery towers 110 and couples to the end plates 108.

The bus bars of the battery assembly 106 may be permanently or releasably connected with the terminals 204 of the battery cells included in the battery assembly 106. The terminals may include a positive and a negative terminal positioned at a first end of the battery cells. The positive and negative terminals may be vertically disposed as illustrated in FIG. 2 such that the battery cells may be connected in series.

The bus bars include first bus bars 208 and second bus bars 210. The first bus bars 208 couple to terminals of the battery cells and connect between adjacent battery towers. The second bus bars 210 connect battery cells within battery towers 110. Therefore, the second bus bars 210 are used to connect the battery cells within a battery tower together in series and the second bus bars are used to connect the battery tower 110 with an adjacent battery tower. The first bus bars 208 enable scaling of the size of the battery assembly 106 as it enables the number of battery towers to be increased or decreased based on size and/or power limitations, constraints, or needs for the system to be powered.

The first bus bars 208 and the second bus bars 210 may be formed of a conductive material such as a metal including copper, bronze, brass, aluminum, or other such materials and may permanently or releasably connect with the terminals 204 of the battery cells. In examples, the first bus bars 208 and the second bus bars 210 may be soldered, welded, or otherwise permanently joined with the terminals 204. In examples, the first bus bars 208 and the second bus bars 210 may be connected with the terminals through a threaded connection or other such releasable connection.

The first bus bars 208 and the second bus bars 210 may be supported in position by frame 206 that defines openings to enable access to the terminals 204. The frame 206 may be formed of an electrically insulative material such as a plastic or a rubber and define a hole or passage for each terminal of the battery tower 110 and/or battery assembly 106. In examples, the frame 206 may be sized for a battery tower 110 with each battery tower 110 having a frame 206. In examples, the frame 206 may be sized for a battery assembly 106. The frame may limit contact between the bus bars and other components of the battery towers 110 and/or battery assembly 106 and therefore provide for reduced possibility of a short or unintended electrical contact.

The frame 206 may be adhered to the battery towers 110 and/or the side of the battery assembly 106 or may be held in place as the bus bars are connected to the terminals 204 through the openings. The bus bars are positioned on a first side of the frame 206 withe the battery tower 110 on a second side of the frame 206. The terminals 204 and/or bus bars extend through the openings in the frame 206.

The bus bars are covered by covers 212 to protect the bus bars from external components as well as to shield from unintentional contact with the battery assembly 106 that may cause damage due to the high voltage of the battery assembly 106. The covers 212 may include recesses (not pictured) or cavities to partially surround the bus bars and to prevent the bus bars from being jostled, displaced, or contacting other components during use of the vehicle.

In examples, the bus bars may be positioned on a single side of the battery towers 110, for example when the battery cells include positive and negative terminals at a first end of the battery cell. In examples, the bus bars may be positioned on both sides of the battery towers 110, for example when the battery cells include positive and negative terminals at opposite ends of the battery cells. In such examples, the battery cells may be arranged within the battery towers 110 such that the battery cells can be connected in series using the bus bars, e.g., with alternating positive and negative terminals at one edge of the battery tower 110.

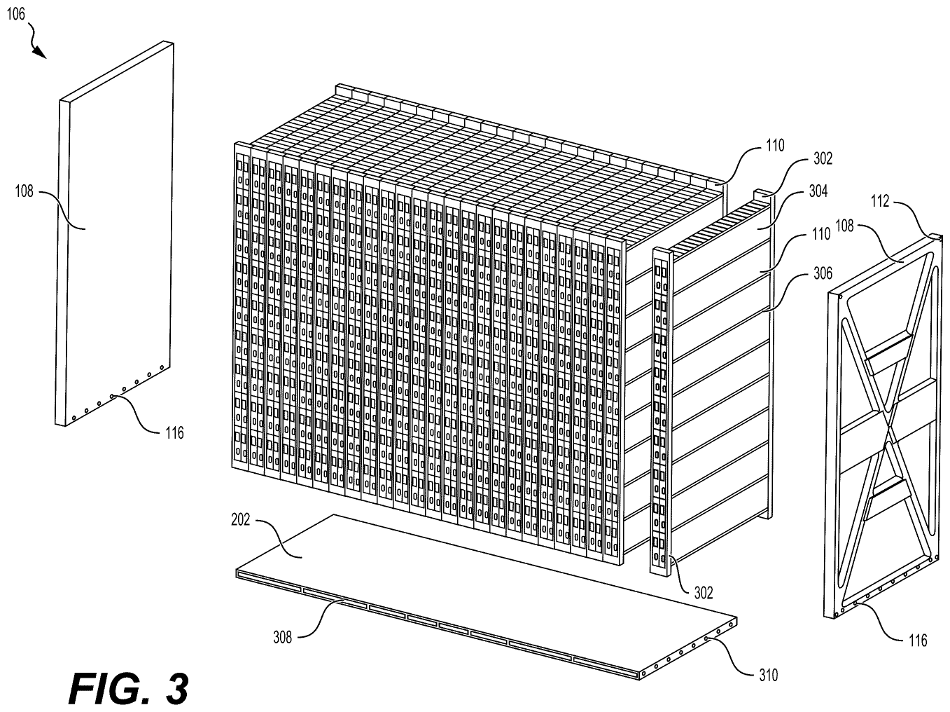

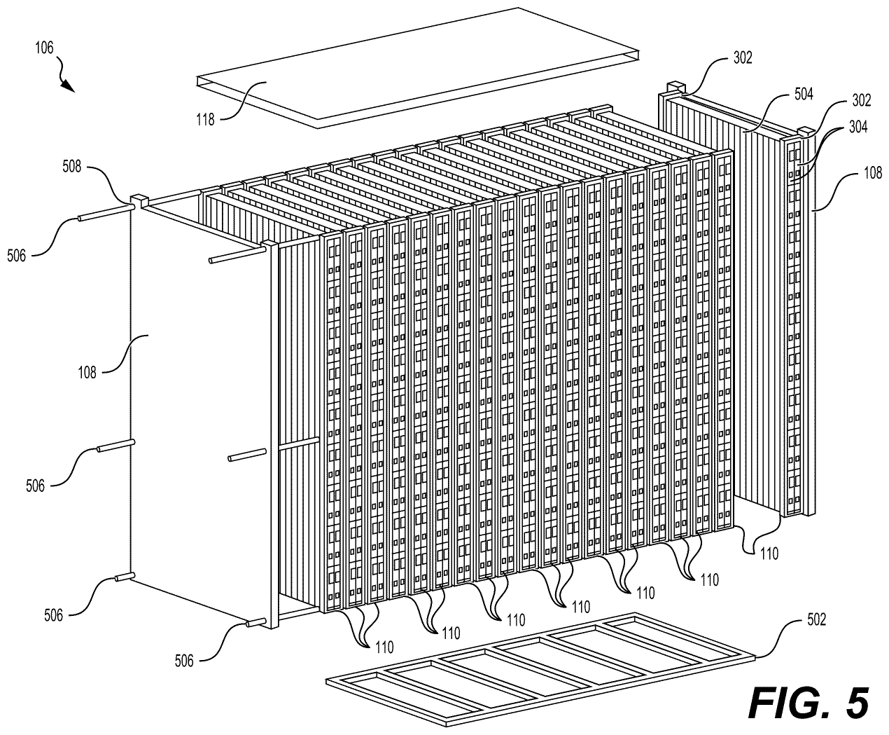

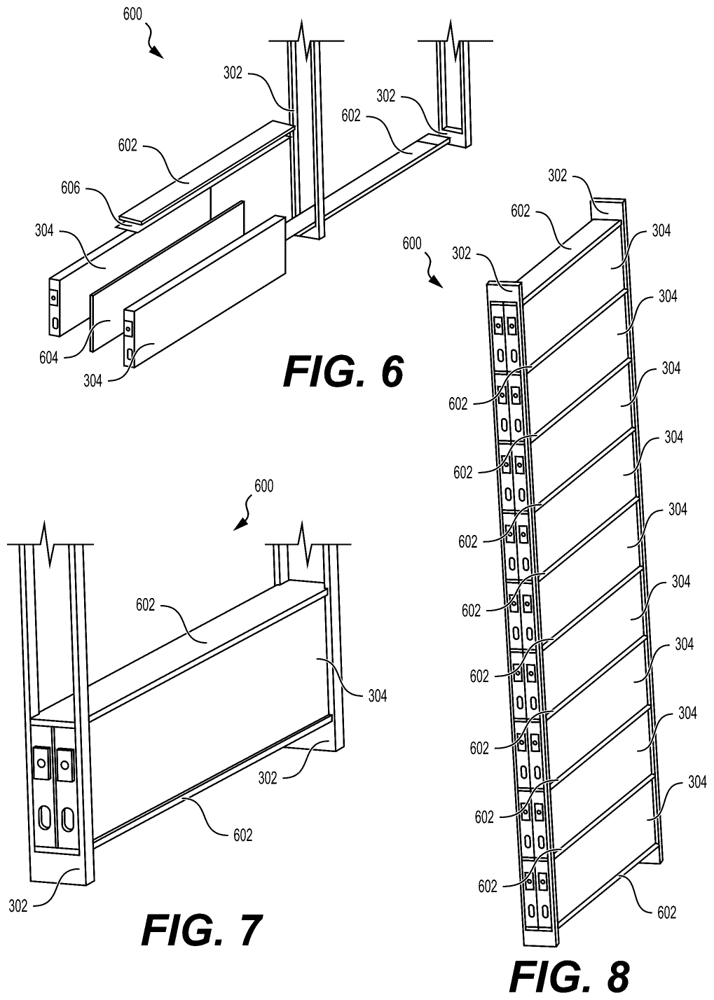

FIG. 3 illustrates an exploded view of a battery assembly 106 showing battery towers 110, support base 202, and end plates 108, according to at least one example. The battery towers 110, discussed in further detail with respect to FIGS. 6-8, are arranged adjacent one another to form the battery assembly 106 between the end plates 108. The battery towers 110 include frames 302 that surround and enclose (e.g., at opposite ends) the battery cells 304 as well as shelves 306. The frames 302 may be formed of a rigid material such as a metal, plastic, or other such material and contains battery cells 304 and shelves 306 within an opening defined by the frames 302. In examples, additional components such as heating elements, cooling elements, thermal management components, compressive material, and other such material may be enclosed by the frames 302. The frames 302 enclose the battery cells 304 (and other components) at a first end and a second end of the battery cells 304 rather than along the entire length of the battery cells 304. This aids in ease of assembly for the battery towers 110 and reduces weight and complexity for the battery assembly 106.

The battery towers 110 are supported or rest on the support base 202. The support base 202 is illustrated as having one or more passages 308, such as defining a torsion box for the support base 202 to reduce the weight of the support base 202. A torsion box includes two flat horizontal surfaces that sandwich a grid or arrangement of crossmembers between them. The torsion box provides for a lightweight arrangement with structural rigidity greater than a single flat sheet for the support base 202. The support base 202 connects with the end plates 108 through threaded connections 310 through the connections 116 of the end plates 108.

As depicted, the battery towers 110 are compressed and secured together by end plates 108 and mounted on support base 202. Each end plate 108 has four holes located on four corners for compression rod installation (e.g., as shown in FIG. 5). The battery assembly 106 with the end plates 108 and support base 202 create a structure that is both resistant to bending and torsion and provides compression on each battery cell 304, particularly on the face side.

In examples, compression may be required for the battery cells 304 to adequately prevent bulging and mitigate vibrations within the battery assembly 106 to prevent mechanical degradation. In examples, the compression may be up to or around compression of 120N. The battery towers 110 may include a gap pad within the frames 302 and/or between adjacent battery towers, the gap pad is comprised of a material with a relatively high thermal conductivity (e.g., not an insulator) and an even surface for heat dissipation and compression. Additionally, the use of silicone or foam can be used in between battery cells 304 to insulate the transfer of heat between adjacent battery cells. The compression for the battery cells 304 is achieved using compression bolts and the end plates 108. The bolts may have a preload that will allow the battery cells 304 to stay under constant compression under cyclic expanding and contracting when charging and discharging. In an example, a total of 6 bolts may be used, positioned at corners of the end plates 108 as well as a mid-point of a long edge of the end plates 108. Each bolt is preloaded with 200N of force to provide the compression of 120N per battery cell 304 as may be required by a manufacturer of the battery cell 304 and/or manufacturer of the vehicle application.

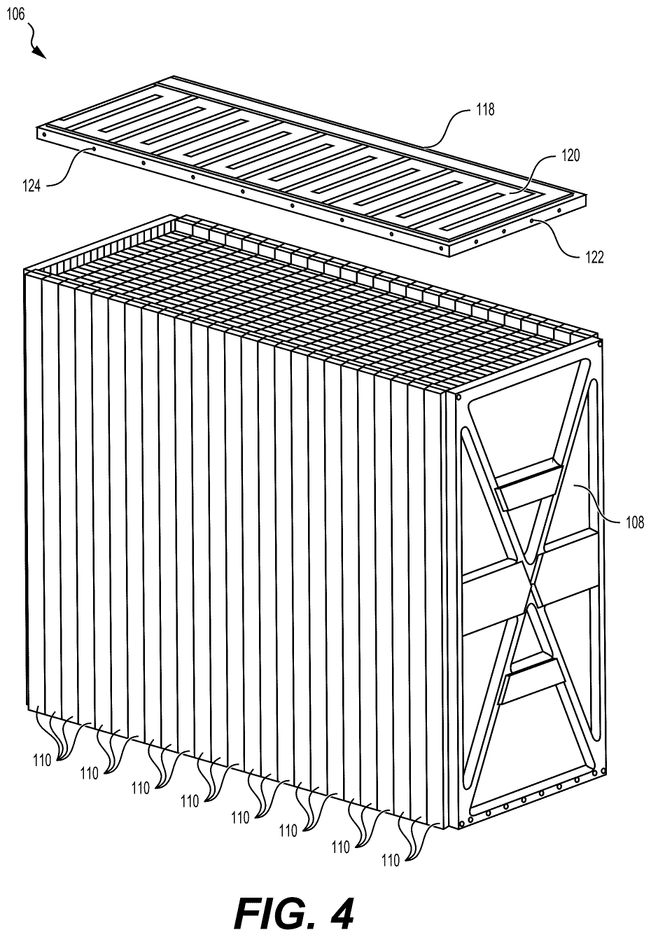

FIG. 4 illustrates a battery assembly 106 including a cold plate 118 positioned at a top end of the battery towers, according to at least one example. The cold plate 118 is positioned opposite the support base 202 and connects to the end plates 108 with connections 122. Additional connections 124 may provide for battery towers 110 (and particularly for frames 302) to connect directly to the cold plate 118 through threaded connections.

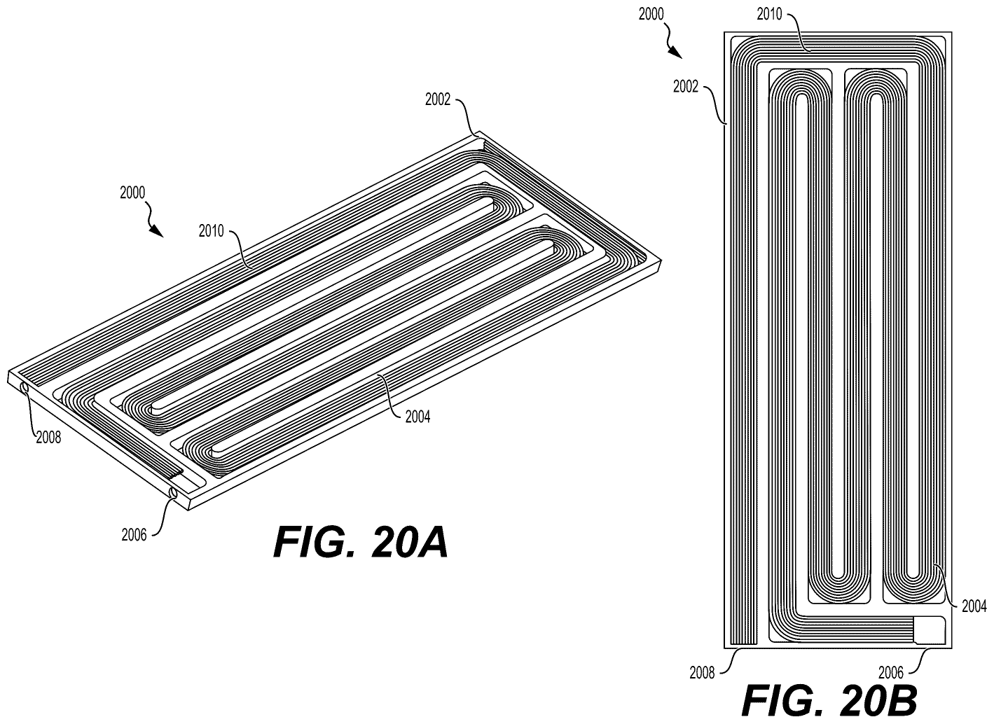

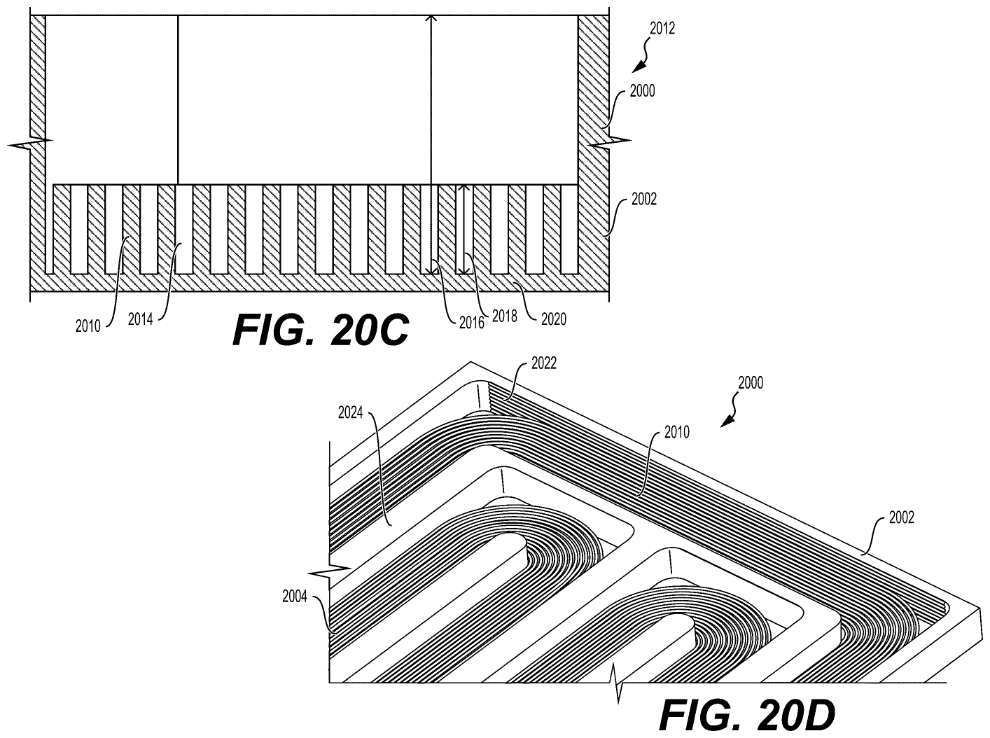

The cold plate 118, described in further detail with respect to FIGS. 20A-D, includes a channel 120 for coolant to flow to transport heat away from the battery towers 110 of the battery assembly 106. In examples, additional heat transfer mechanisms may be used to transport heat along the height of the battery towers 110 to reach the cold plate 118, where heat is transferred away from the battery assembly 106. The cold plate 118 serves to effect heat removal and serve as the condensing cold source for the battery assembly 106.

FIG. 5 illustrates a battery assembly 106 and compression rods 506 for compressing the battery towers 110 together between end plates 108, according to at least one example. The battery assembly 106 is shown in an exploded view with the battery towers 110 arranged as described herein, within frames 302 and also shows a frame 502 for a support base rather than a torsion box, as described with respect to FIG. 2. The frame 502 may provide for support of the battery towers 110 as well as being lightweight and compact, similar to the torsion box of the support base 202.

The battery towers 110 are shown with heat pipes 504 extending along the height of the battery towers 110. The heat pipes 504 may include a series of pipes arranged parallel with each other and running from a bottom end of the battery towers 110 to a top end of the battery towers 110. The heat pipes 504 may employ phase transitions to transfer heat from the battery towers 110 to the top end of the battery tower 110 to interface with the cold plate 118. Within the heat pipes 504, at a hot interface, a volatile liquid in contact with a thermally conductive solid surface turns into a vapor by absorbing heat from that surface. The vapor then travels along the heat pipes 504 to the cold interface at the top of the battery tower 110 adjacent the cold plate 118 and condenses back into a liquid, releasing the latent heat. The liquid then returns to the hot interface through capillary action and/or gravity and the cycle repeats.

In examples, compression may be required for the battery cells 304 to adequately prevent bulging and mitigate vibrations within the battery assembly 106 to prevent mechanical degradation. In examples, the compression may be up to or around compression of 120N. The battery towers 110 may include a gap pad within the frames 302 and/or between adjacent battery towers, the gap pad is comprised of a material with a relatively high thermal conductivity (e.g., not an insulator) and an even surface for heat dissipation and compression. Additionally, the use of silicone or foam can be used in between battery cells 304 to insulate the transfer of heat between adjacent battery cells. The compression for the battery cells 304 is achieved using compression rods 506 and end plates 108. The compression rods 506 may have a preload that will allow the battery cells 304 to stay under constant compression under cyclic expanding and contracting when charging and discharging. In an example illustrated in FIG. 5, a total of 6 compression rods 506 are be used, positioned at corners of the end plates 108 as well as a mid-point of a long edge of the end plates 108 and passing through openings 508 within the end plates 108. Each compression rod 506 is preloaded with 200N of force to provide the compression of 120N per battery cell 304 as may be required by a manufacturer of the battery cell 304 and/or manufacturer of the vehicle application.

FIGS. 6-8 illustrate a portion of a battery tower 600 during an assembly process, according to at least one example. The battery tower 600 includes frames 302 that form rings to enclose ends of the battery cells 304. In an example, the battery tower 600 may include an array of eighteen battery cells, such as blade cells of L600 format with “standard” dimensions of 574 mm (L) by 118 mm (H) by 21.5 mm (W) in an arrangement of nine two-cell pair blocks (e.g., pairs of battery cells next to one another), which is a pair of two cells stacked nine pairs high and separated horizontally by shelves 602 and separated by a compression foam 604 sandwiched in-between.

The two-cell pair block is installed between the two frames 302 illustrated as structural ring frames, and having shelves 602 made of high-strength aluminum or steel, which may be mechanically fastened to the frames 302. The top surface of the shelves 602 is lined with a compression foam. The inner surfaces of the frames 302 are coated with Teflon (R) to reduce friction and avoid damage to the battery cells 304 due to vibration. For example, a 0.11 mm thick Teflon sheet may be placed inside the frames 302 and allow the battery cells 304 to slide into the pack easily during assembly and mitigate any scratching.

After the first two-cell pair is inserted into the frames 302 as depicted in FIG. 6, a shelf is installed on top of the two-cell pair, as depicted in FIG. 7 and then a subsequent two-cell pair is then installed in a similar manner by installing shelves 602 with compression foam attached to both top and bottom surfaces of the shelves 602 to form the battery tower 600 depicted in FIG. 8.

In examples, the battery tower 110 is formed by attaching individual pre-cut thermally conductive gap pad (e.g., compressive material) onto each exposed battery cell surface, e.g., 18 in total, and pressed firmly against the heat pipes 504 of FIG. 5.

The frames 302 provide for the battery cells 304 to be mounted using a thin sheet of metal that is bent around the battery cells 304. Additionally, shelves 602 between the frames 302 provides structural support to the battery cells 304. The structure reduces the strain of the battery cells 304 resting weight onto each other. The frames include holes at the corners to receive the compression rods 506 to compress the battery cells and serve as a connection between each battery tower 600. The design of the battery tower 600 enables the battery cells to have contact with thermal management components such as the heat pipes 504 through a gap pad or foam.

Assembly of the battery assembly 106 begins by forming the battery towers 600. Each battery tower 600 may hold the same number of battery cells 304, for example eighteen battery cells in a 2×9 arrangement that will have shelves 602 in between. The shelves 602 may connect to the frames 302 through countersunk screws and support the weight of the battery cells 304. Each battery cell 304 has foam or other compressive material in between the neighboring battery cell 304 and on the top and bottom. In examples, the foam pads may be tacked onto the battery cells 304 and provide a surface for uniform heat dissipation and compression.

In examples, the battery cells 304 may need to be heated an ambient temperature of −20° C. up to an operating temperature of 0° C. for battery operation. Other temperature ranges are also contemplated. The heating process may for the battery cells 304 may be accomplished through the use of a thermal management component that may be used in connection with a compressive foam 606 such as an adhesive-mount heating pad that may be situated on the shelves 602 in addition to a compressive foam.

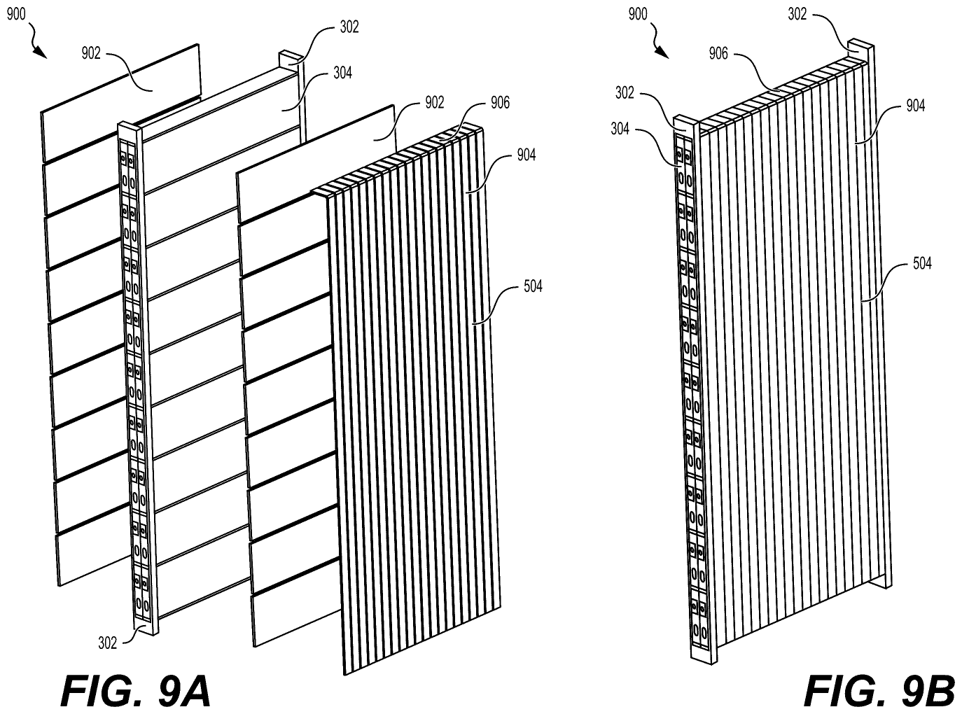

FIGS. 9A-9B illustrate a battery tower 900 with compressive material 902 and heat pipes 504, according to at least one example. The battery tower 900 includes frames 302 enclosing battery cells 304, for example as shown and described with respect to FIGS. 6-8. The battery tower 800 is illustrated with compressive material 902 applied to an exterior surface of the battery cells 304 between the battery cells and the heat pipes 504.

The compressive material 902 may include a thermally conductive gap pad that fills a gap between the battery cells 304 and the heat pipes 504 to enable efficient heat transfer to the heat pipes 504 from the battery cells 304. The compressive material 902 may include soft and conformable pads to eliminate air gaps as well as provide shock dampening between the battery cells 304 and the heat pipes 504, or other components of the battery towers 900.

The heat pipes 504 may include two sections, a first section 904 that extends vertically along the height of the battery tower 900 and a second section 906 that extends horizontally across a top surface of the battery tower 900. The first section 904 may transport heat along the height of the battery tower 900. The second section 906 may provide a contact area for contacting or being adjacent the cold plate 118 and therefore provide for heat transfer through the contact area to the cold plate 118. Each of the first section 904 and the second section 906 may include a series of pipes or micro-pipes arranged parallel with each other and running from a first end to a second end of the section. The heat pipes 504 may employ phase transitions to transfer heat from the battery towers 900 to the top end of the battery tower 900 to interface with the cold plate 118. Within the heat pipes 504, at a hot interface, a volatile liquid in contact with a thermally conductive solid surface turns into a vapor by absorbing heat from that surface. The vapor then travels along the heat pipes 504 to the cold interface at the top of the battery tower 900 adjacent the cold plate 118 and condenses back into a liquid, releasing the latent heat. The liquid then returns to the hot interface through capillary action and/or gravity and the cycle repeats.

FIGS. 10A-10B illustrate example sections 1000 of battery towers 110 in a battery assembly 106 before and after compression during assembly, according to at least one example. When compressing the battery assembly 106 it is important that the compression is applied steadily to the battery cells 304 such that they are under uniform compression in order to prevent delamination of the inner battery. When assembling the battery tower 110, the battery cells 304 are arranged with compression material 1002 in-between the cells. Additionally, each of the shelves 602 may include compressive foam 606 on the tops and bottoms thereof.

Between the battery towers 110, gap pads 1006 are positioned next to heat pipes 504. The gap pads 1006 include material with high thermal conductivity to allow cooling of the battery cells 304. The gap pads 1006 may have a thermal conductivity of about 5 W/mK, though in other examples, other gap pads 1006 having varying thermal conductivity may be implemented. The thermal conductivity of the gap pad enables the heat pipes 504 to conduct heat through the material. In an example, the gap pad 1006 has a thickness of 4.5 mm as the space between the two battery towers 110 (without a gap pad 1006 and heat pipes 504) has a space of about 10 mm. The gap pad 1006 is naturally a very stiff material and may require a high compression force per surface area of the heat pipe to compress.

Since the stiffness of the gap pad 1006 is significantly greater than the stiffness of the compression material 1002, during assembly, the gap pad 1006 is pre-compressed using a stamping manufacturing process for the gap pad 1006 to be compressed without causing an issue. As illustrated in FIG. 10B, after compression by the compression rods, the example section 1008 shows that the compression material 1002 reduces in thickness from first thickness 1004 to second thickness 1010.

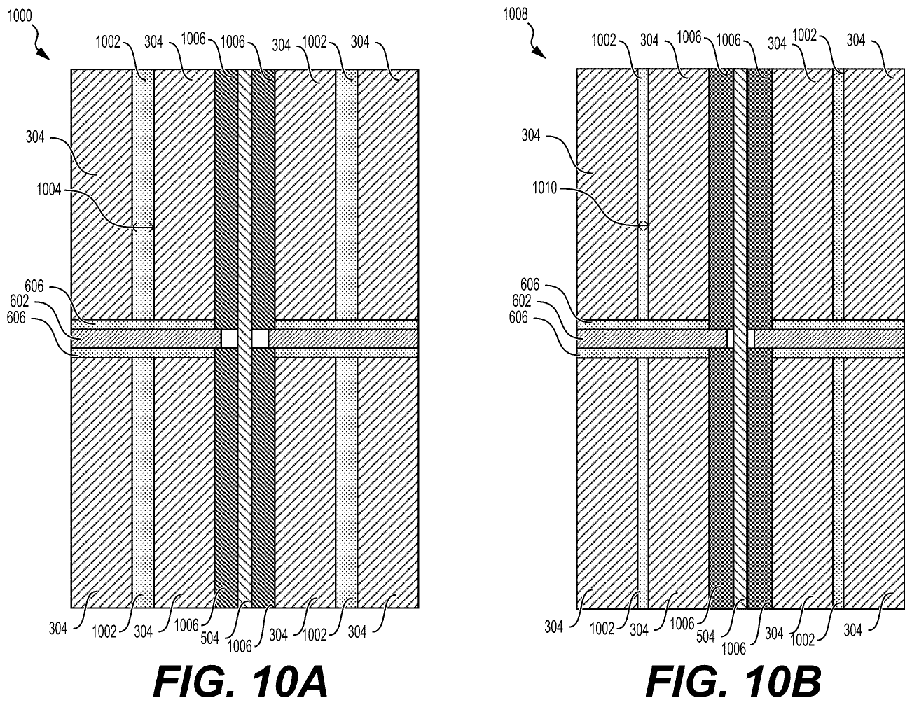

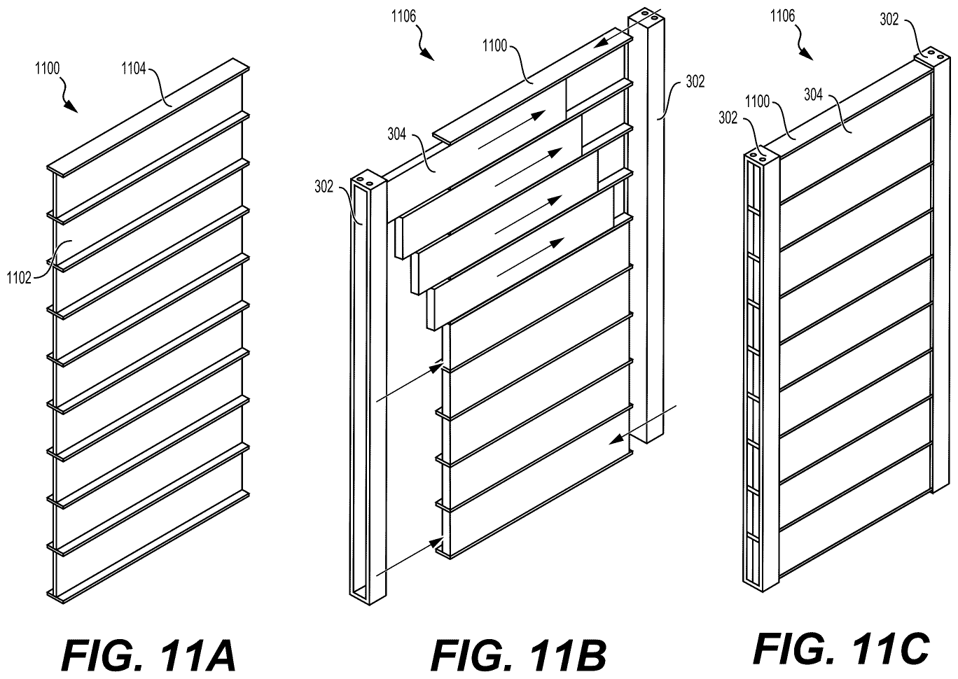

FIGS. 11A-11C illustrate a battery tower 1106 having a central support frame 1100 during assembly, according to at least one example. In examples, such as described with respect to FIGS. 6-8, the central support frame 1100 may be omitted. The central support frame 1100 uses a tree-like structure to hold and support all of the battery cells 304 within the frames 302. The two frames 302 include ring-like structures that are placed at the ends of the battery cells 304 and the central support frame 1100 to cradle the battery cells in place and the frames 302 are screwed into the top and bottom using countersunk screws to keep everything flush.

The central support frame 1100 includes a vertical portion 1102 and horizontal portions 1104. The vertical portion 1102 provides a rigid frame as well as compression material as described herein, which may be applied to an out surface of the vertical portion 1102. The horizontal portions 1104 may be similar to the shelves 602 and similarly include compressive material, but may be permanently coupled with the vertical portion 1102. In examples, the horizontal portions 1104 may be removable and/or adjustable to various positions along the height of the vertical portion 1102. In examples, the central support frame 1100 may include a heat transfer mechanism such as heat pipes as described herein. The heat transfer mechanism may enable heat transfer along the height of the battery tower 1106 to reach the cold plate 118 as described herein.

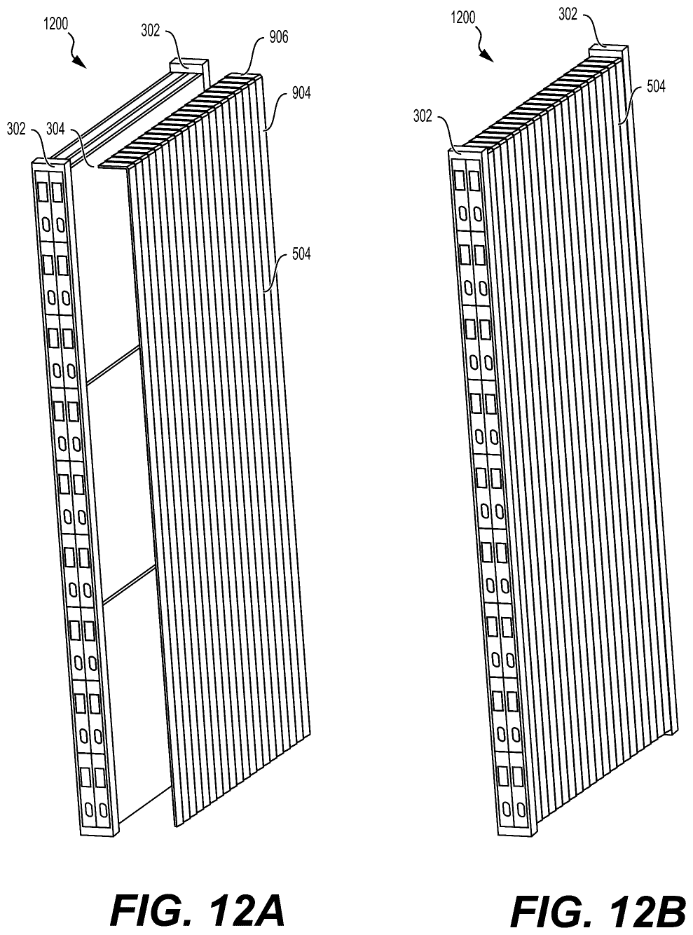

FIGS. 12A-12B illustrate a battery tower module 1200 with heat pipes 504 on an outer surface, according to at least one example. As described above, with respect to FIG. 9, the heat pipes 504 include a first section 904 and a second section 906. Once the battery tower module 1200 is assembled, with the frames 302 around the battery cells 304 and other components such as shelves, central structures, compression material, and other such components as described herein, then the gap pad is applied to an outer surface of the battery cells 304 and/or to an inner surface of the heat pipes 504. The arrangement of heat pipes 504 with a plurality of parallel heat pipes may be implemented into the battery tower module 1200. The heat pipes 504 will be held in place due to the compression used for the battery assembly 106. The heat pipes 504 extend up and over the top of the battery tower module 1200, but are still flush against the top surface (e.g., and flush with the top edge of the frames 302) to allow for the cold plate 118 to be placed over them in the battery assembly 106. In an example, this arrangement of the heat pipes 504 allows for 50 mm or more of length of the heat pipes 504 to be in contact with the cold plate 118.

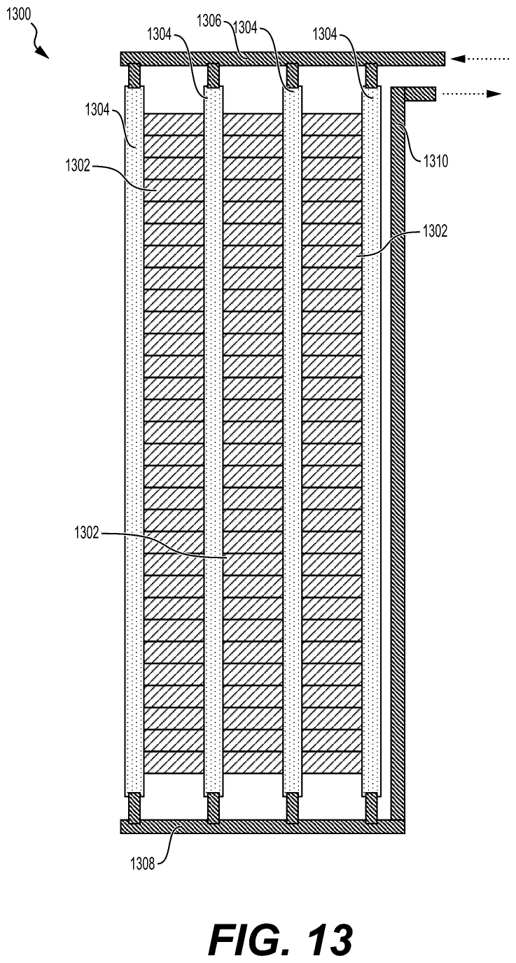

FIG. 13 illustrates a section view of a battery assembly 1300 showing a flow path for coolant through an active cooling system, according to at least one example. In an example, a stack of battery cells 1302 are arranged into battery towers. A cold plate 1340 is positioned between adjacent battery towers. The cold plate 1304 may replace the heat pipes 504 described herein to provide coolant flow between the battery towers. In an example, the battery cells 304 may be arranged as described with respect to FIGS. 6-8 or may be arranged in a flat configuration (e.g., with the large surface of the battery cell horizontal). The coolant flows into an inlet 1306 that feeds each of the cold plates 1304 and out of an outlet 1308 coupled to an opposite end of each of the cold plates. The outlet 1308 is fluidly coupled with an exit where the coolant is delivered to dispose of the heat, such as at a radiator, before returning to the inlet 1306.

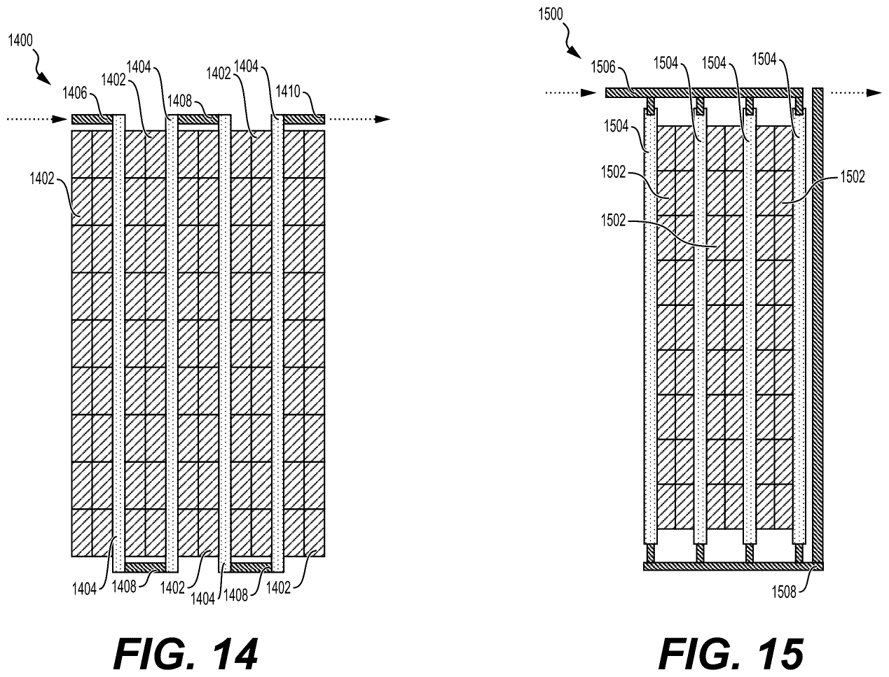

FIG. 14 illustrates a section view of a battery assembly 1400 showing a flow path for coolant through an active cooling system, according to at least one example. As contrasted with FIG. 14, the battery assembly 1400 includes a series of cold plates arranged in series rather than the parallel configuration of FIG. 13. The battery assembly 1400 includes battery cells 1402 arranged into battery towers with cold plates 1404 disposed between the battery towers. The cold plates 1404 are fed by an inlet 1406 at a first end of the assembly. The cold plates 1404 are connected in series by couplings 1408 until an outlet 1410 at a second end of the assembly. In this manner, the coolant may be transported across the length of the battery assembly 1400 before being transported away to dispose of the accumulated heat.

FIG. 15 illustrates a section view of a battery assembly 1500 showing a flow path for coolant through an active cooling system, according to at least one example. The arrangement of the battery assembly 1500 is similar to the battery assembly 1300 of FIG. 13 with battery cells 1502 arranged into towers separated by cold plates 1504 that connect to inlet rail 1506 and outlet rail 1508. The inlet rail 1506 is fed at a first end of the battery assembly 1500 while the outlet rail exits at a second end of the battery assembly 1500. The arrangement of FIG. 14 allows for less overall tubing and therefore less weight and expense but also results in poorer thermal management as the coolant becomes heat soaked before passing all of the battery cells. However, the parallel design of FIGS. 13 and 15 provides for improved cooling performance.

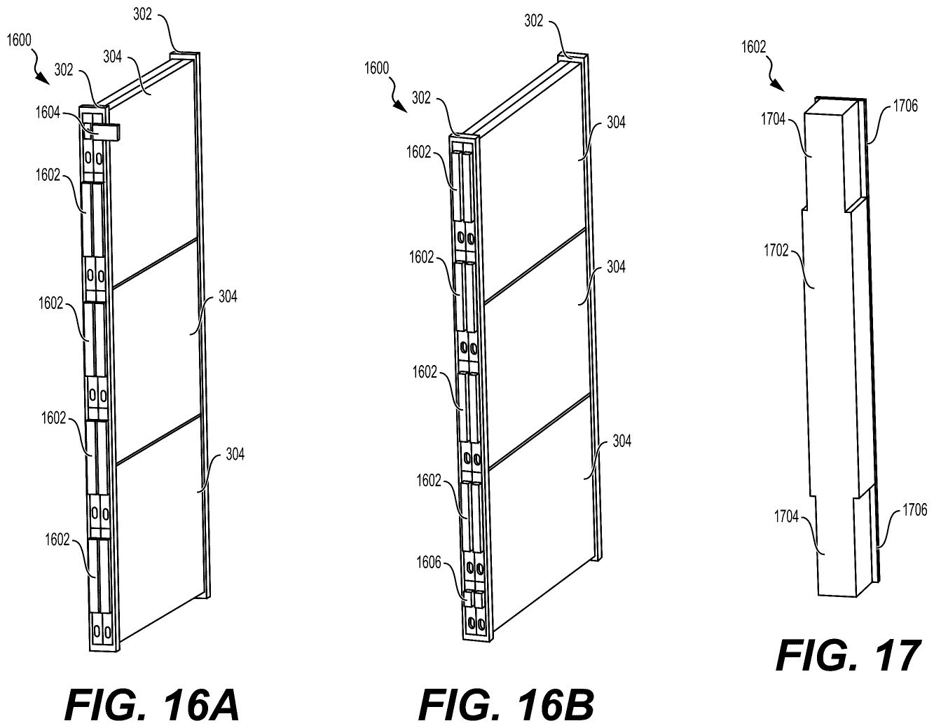

FIGS. 16A-16B illustrate a first end and a second end of a battery tower 1600 showing bus bars for electrical connections, according to at least one example. The battery tower 1600 includes bus bars 1602 for electrically connecting battery cells 304 as well as electrically connecting adjacent battery towers in series to produce the battery assembly 106 having a target energy storage capacity (e.g., a target voltage etc.).

The bus bars 1602 may be permanently or releasably connected with the terminals of the battery cells 304. The terminals may include a positive and a negative terminal positioned at a first end of the battery cells. The bus bars include bus bars 1602 and bus bars 1604. The bus bars 1602 couple to terminals of the battery cells and connect battery cells within a battery tower 1600. The bus bars 1604 connect to adjacent battery towers.

The bus bars 1602 and the bus bars 1604 may be formed of a conductive material such as a metal including copper, bronze, brass, aluminum, or other such materials and may permanently or releasably connect with the terminals of the battery cells 304. In examples, the bus bars 1602 and the bus bars 1604 may be soldered, welded, or otherwise permanently joined with the terminals. In examples, the bus bars 1602 and the bus bars 1604 may be connected with the terminals through a threaded connection or other such releasable connection.

FIG. 17 illustrates a bus bar 1602 for connecting terminals of adjacent battery cells, according to at least one example. The bus bar 1602 is a metallic strip used as a connecting junction between multiple inputs and outputs within a circuit. The bus bars 1602 are used within switch boards and high current power distribution situations, such as a large battery pack. The bus bar 1602 and the bus bars 1604 may be laser welded onto the terminals via machined tabs to create a complete circuit in series.

The bus bar 1602 includes a middle portion 1702 and two end portions 1704. The middle portion 1702 of the bus bar 1602, configured for conducting high electric current flow, may be solid and/or formed of a braided and/or layered conductive material. The use of a layered, braided, or otherwise flexible conductive material may reduce or minimize stress on the welds of the end portions 1704 to the terminals. In examples, the middle portion 1702 has a greater thickness than the end portions 1704. The end portions 1704 include a flange 1706 that is used to laser weld onto the terminals. The flange 1706 may have a thickness that may be melted in a laser welding application to join the terminal and the bus bar 1602.

In a battery application, the bus bars 1602 may need to withstand up to or in excess of four hundred Amp hours (Ah) produced from the cells. Accordingly, the bus bar may be formed of a conductive material such as aluminum or copper, with a primary difference being the ampacity of each. Ampacity is the maximum current that a conductor can carry continuously under the conditions of use without exceeding its temperature rating. A larger ampacity requires a smaller cross-sectional area for the bus bars. Copper has a higher ampacity per area than aluminum.

The flange 1706 at the end portions 1704 of the bus bar 1602 may be machined onto the bus bars, e.g., by removing material from a rectangular solid of conductive material. In an example, the flange 1706 may result in a 1 mm×2 mm×32 mm tab on all 4 corners of the bus bar 1602. This flange 1706 allows a small enough thickness for a laser weld to go straight through the conductive material. In an example, the bus bar 1602 may have dimensions of about 16 mm×18.17 mm×158.5 mm.

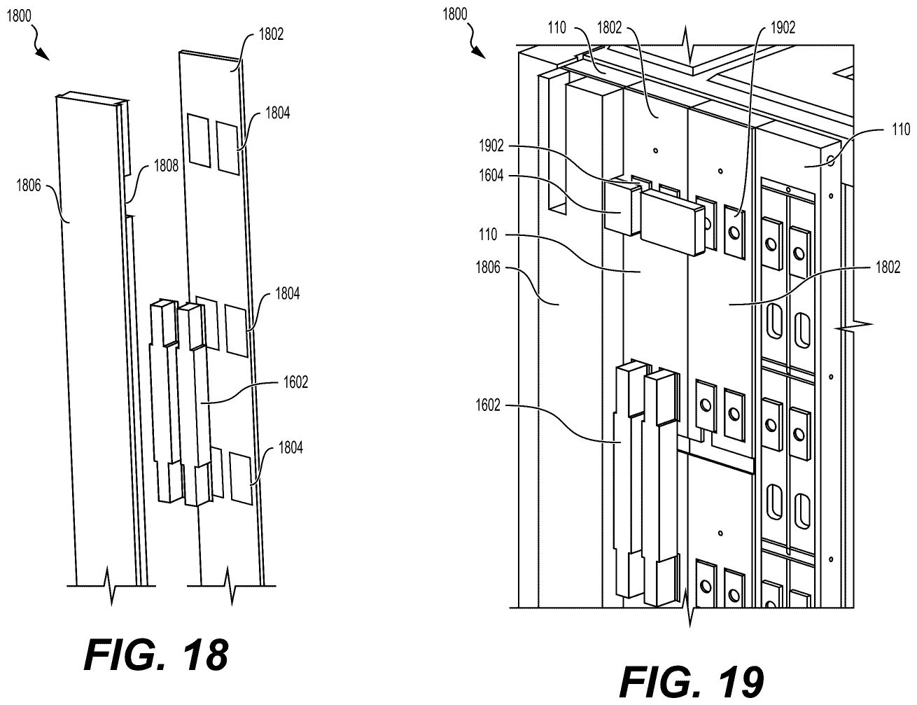

FIGS. 18-19 illustrate an electrical connection system 1800 including bus bars 1602 and covers 1806 for aligning, covering, and protecting bus bars 1602 after installation, according to at least one example. The electrical connection system 1800 further includes a frame 1802 and is designed to protect the bus bars from damage as well as arcing. Arcing occurs when two electrical sources are too close together, causing the current from one source to travel through the air to another. The frame 1802 and the cover 1806 are implemented to prevent arcing and damage to the bus bars 1602 and terminals.

The frame 1802 extends the height of the battery tower and is inserted prior to the bus bar welding. The frame 1802 defines openings 1804 to provide access to the terminals 1902 through the frame 1802. The frame 1802 protects against arcing on the backside of the bus bars 1602, as well as protection against interactions with the frames of the battery towers 110. The openings 1804 are wider than the terminals and/or bus bars to allow for thermal expansion and ease the amount of force applied to the welds. The frame 1802 also provides channels directed towards every other bus bar which provide a channel to run flex PCB thermocouples through to the battery cells.

After the bus bars 1602 are laser welded to the terminals, the cover 1806 is placed over the bus bars 1602. The cover 1806 defines cutouts 1808 and surrounds the remaining side of the bus bar 1602, preventing arcing from occurring between, underneath, and overtop the bus bars 1602. It may also be used to secure and seal off the PCB sensors and heat tape wires. The cover 1806 also acts as a safety measure, ensuring that no operator or maintenance personnel can access the high voltage bus bars.

FIGS. 20A-20D illustrate a cold plate 2000 for thermal management of a battery assembly 106, according to at least one example. The cold plate 2000 may be an example of the cold plate 118 described herein. The cold plate 200 may be used as a condenser for the heat pipes 504. The cold plate 200 includes walls 2002, channel 2004, inlet 2006, and outlet 2008. The cold plate 2000 provides a route through the channel 2004 to direct coolant and thereby remove heat from the battery assembly 106.

The cold plate 2000 may be machined to form the channel 2004 and provide a coolant flow path and covered with a cover plate (not pictured). The cold plate 2000 may be formed of a thermally conductive material such as aluminum or copper. The cold plate 2000 may have a channel 2004 that follows any particular path within the cold plate 200. Due to the high density of battery cells and the potential for high amounts of heat to be generated during charging or discharge, the cold plate 2000 includes additional features to increase the surface area within the channel 2004 and improve the heat transfer capabilities of the cold plate 2000.

As shown in FIGS. 20A-20D, fins 2010 are introduced within the channel 2004 to increase the surface area of the cold plate 2000 in contact with the coolant and thereby increase the heat transfer rate to the coolant. FIG. 20C illustrates an example section view 2012 of the fins 2010 within the channel 2004. The fins 2010 are separated by gaps 2014 through which coolant flows. The fins 2010 are shown extending from a bottom 2020 of the channel 2004 and extending a first distance 2018 into the channel 2004. The first distance 2018 is less than a depth 2016 of the channel 2004 in some examples. The fins 2010 may increase a resistance to flow of the coolant, and thereby reduce a coolant flow rate through the cold plate 2000 if the fins 2010 extend the depth 2016. Accordingly, the fins 2010 only extend a portion of the distance to prevent flow restriction to the coolant. In some examples, the spacing of the fins 2010 may be increased to reduce the flow restriction, and thereby enable the height of the fins 2010 to be extended.

FIG. 20D further illustrates that fins 2022 may extend from the walls 2002 of the cold plate 200 and not just the bottom 2020. The fins 2010 and fins 2022 may have a straight profile (e.g., all fins extend to an equal height across the length of the fins), wave (e.g., sinusoidal profile along the length of the fins) or other shape to balance the increased surface area and limit the flow restrictions for the coolant. In examples, the fins 2010 and fins 2022 may be machined into the cold plate or may be brazed or welded to the channel 2004.

Reference was made to the examples illustrated in the drawings, and specific language was used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features, it is to be understood that the subject matter defined in the appended claims is not necessarily limited to the specific features described. Rather, the specific features are disclosed as illustrative forms of implementing the claims.

### INDUSTRIAL APPLICABILITY

The present disclosure provides systems and methods for a battery tower assembly for fitting within a chassis of a heavy-duty machine in spaces left by removing a previous powertrain. In such a chassis, such as was designed for a diesel fuel powertrain, or other such fuels source, the spaces remaining in the chassis may not be suitable for efficient packing of typical battery assemblies based on existing battery structures. The systems and structures described herein provide for a battery system that applies a cell-to-pack concept to fill such non-traditional spaces within the chassis.

Electrification of heavy-duty equipment, large machines, mining trucks, etc., may involve replacement of a large diesel engine with an electric powertrain that occupies less space and leaves behind large irregular spaces. In some examples, the space no longer occupied by the powertrain may be narrow and tall, such as an engine compartment that does not fit well with common battery module or pack designs. The use of a cell-to-pack (CTP) configuration and assembly concept enables use and efficient packing within the spaces of the chassis previously occupied by the powertrain components while also improving energy density, cooling, and integral structural components.

While traditional battery packs comprise cells, assembled into modules, and then integrated into a pack structure, the CTP design eliminates the need for modules by directly integrating cells into the pack structure. In doing so, the CTP design simplifies the overall architecture, reduces weight and volume, and improves energy density and thermal management. The CTP integrates battery cells directly into a pack without the intermediate step of modules, thereby further enhancing the volumetric energy density of battery mold and system compared to the conventional pack.

The CTP design of the battery assembly described herein enables improved energy density over typical battery arrangements due to the reduced structure by avoiding implementation into a module level. Accordingly, the energy density of the battery assembly is improved over conventional battery pack designs. The battery assembly provides for reduced weight and volume as a result of the higher energy density than a conventional battery system, in particular at least because the battery assembly does not use additional casings, connectors, and other components that may be implemented in a battery module. Additionally, the battery assembly may be produced with fewer steps, complexity, and cost than typical battery packs that are arranged from cells into modules and then into packs.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

1. A battery tower comprising:
a plurality of modular structures shaped to fit within an existing compartment of a heavy-duty vehicle, wherein a modular structure of the plurality of modular structures comprises:
a first frame having an elongated rectangular shape and defining a first opening having a first length and a first width;
a second frame having the elongated rectangular shape and defining a second opening having the first length and the first width;
a plurality of battery cells arranged in a stack configuration, wherein the stack configuration comprises a thickness of two battery cells and a height of at least two battery cells; and
a compressible material positioned between adjacent battery cells of the plurality of battery cells in the stack configuration, wherein:
the stack configuration is situated within the first opening of the first frame and the second opening of the second frame; and
the first frame and the second frame compress the compressible material.

2. The battery tower of claim 1, further comprising:
a first end plate positioned at a first side of the plurality of modular structures; and
a second end plate positioned at a second side of the plurality of modular structures opposite the first side, wherein the first end plate and second end plate are connected together to secure and compress the plurality of modular structures.

3. The battery tower of claim 1, further comprising first bus bars arranged along a first end of the plurality of modular structures and second bus bars arranged along a second end of the plurality of modular structures, wherein:
the first bus bars comprise a conductive material held in place by a third frame and configured to electrically connect adjacent battery cells; and
the second bus bars comprise the conductive material held in place by a fourth frame and configured to electrically connect adjacent battery cells.

4. The battery tower of claim 1, further comprising a cold plate extending across at least a portion of a top of the plurality of modular structures.

5. The battery tower of claim 4, wherein the cold plate defines:
a passageway through the cold plate; and
a plurality of fins extending from a wall of the passageway and configured to transfer heat to a working fluid of the cold plate.

6. The battery tower of claim 1, further comprising heat pipes positioned between adjacent modular structures of the plurality of modular structures.

7. The battery tower of claim 1, further comprising a heat management device positioned between adjacent battery cells, the heat management device configured to selectively heat the plurality of battery cells.

8. A battery tower module comprising:
a first frame having an elongated rectangular shape and defining a first opening having a first length and a first width;
a second frame having the elongated rectangular shape and defining a second opening having the first length and the first width;
a plurality of battery cells having an elongated rectangular shape arranged in a stack configuration with the first frame surrounding a first end of the stack configuration and the second frame surrounding a second end of the stack configuration to secure the plurality of battery cells, wherein:
a battery cell of the plurality of battery cells has first side, a second side, a top edge, and a bottom edge; and
the stack configuration comprises the plurality of battery cells stacked with the top edge of a first battery cell adjacent a bottom edge of a second battery cell and a first side of the first battery cell adjacent a second side of a third battery; and
a compressible material positioned between adjacent battery cells of the plurality of battery cells in the stack configuration.

9. The battery tower module of claim 8, further comprising an internal frame comprising a vertical component and a plurality of support components extending from the vertical component, the plurality of support components configured to support the plurality of battery cells.

10. The battery tower module of claim 8, further comprising a heat management device positioned between adjacent battery cells, the heat management device configured to selectively heat the plurality of battery cells.

11. The battery tower module of claim 8, further comprising heat pipes extending along a height of the battery tower module and along a thickness of the battery tower module at a top end of the battery tower module.

12. The battery tower module of claim 8, further comprising first bus bars arranged along a first end of the plurality of battery cells and second bus bars arranged along a second end of the plurality of battery cells.

13. The battery tower module of claim 12, wherein the first bus bars and the second bus bars comprise:
a rectangular body extending along a first direction;
a first end portion and a second end portion each having a width less than a width of a middle portion; and
a flange extending from a first side of the rectangular body at the first end portion and the second end portion.

14. The battery tower module of claim 12, wherein:
the first bus bars comprise a conductive material held in place by a third frame and configured to electrically connect adjacent battery cells; and
the second bus bars comprise the conductive material held in place by a fourth frame and configured to electrically connect adjacent battery cells.

15. The battery tower module of claim 8, further comprising a second compressible material positioned between the plurality of battery cells and the first frame and the second frame.

16. A battery module comprising:
a first end plate positioned at a first end;
a second end plate positioned at a second end of the battery module;
a plurality of modular battery towers positioned between the first end plate and the second end plate, a modular battery tower of the plurality of modular battery towers comprising:
a first frame having an elongated rectangular shape and defining a first opening having a first length and a first width;
a second frame having the elongated rectangular shape and defining a second opening having the first length and the first width;
a plurality of battery cells arranged in a stack configuration with the first frame surrounding a first end of the stack configuration and the second frame surrounding a second end of the stack configuration to secure the plurality of battery cells; and
a compressible material positioned between adjacent battery cells of the plurality of battery cells in the stack configuration.

17. The battery module of claim 16, further comprising a cold plate adjacent a top end of the plurality of modular battery towers defining a channel for coolant to flow through, the channel including a plurality of fins extending into a coolant flow volume enclosed by the cold plate.

18. The battery module of claim 17, wherein:
the fins extend a first distance, the first distance less than a second distance defining a diameter or height of the channel; and
the fins have a first thickness and a distance between adjacent fins that corresponds to the first thickness.

19. The battery module of claim 17, wherein the fins have a first height extending from a surface defining the channel, the first height varying over a length of the fins.

20. The battery module of claim 17, wherein the fins may be positioned on a base portion of the channel and a wall portion of the channel as defined by the cold plate.
